(19) United States
(12) Patent Application Publication
(10) Pub. No.: US 2021/0336666 A1
(43) Pub. Date: Oct. 28, 2021

(54) LAYER PRECODING FOR MOBILE CHANNELS

(71) Applicant: QUALCOMM Incorporated, San Diego, CA (US)

(72) Inventors: Igor Gutman, Ramat Gan (IL); Michael Levitsky, Rehovot (IL); Guy Wolf, Rosh Haayin (IL); Sharon Levy, Binyamina (IL)

(21) Appl. No.: 16/857,488

(22) Filed: Apr. 24, 2020

(51) Int. Cl. H04B 7/0456; H04L 5/10; H04L 5/00; H04B 7/06; H04B 7/0417

(52) U.S. Cl. CPC H04B 7/0465; H04L 5/10; H04L 5/0055; H04B 7/0626; H04B 7/0417; H04L 5/0051

(57) ABSTRACT

In one aspect, a method of wireless communication includes generating, by a user equipment (UE), a delta precoding value for a precoding matrix update, the delta precoding value relative to a previous precoding matrix. The method also includes generating, by the UE, a delta power loading value for the precoding matrix update, the delta power loading value relative to the previous precoding matrix. The method further includes transmitting, by the UE, a transmission indicating the delta precoding value and the delta power loading value. Other aspects and features are also claimed and described.

### TECHNICAL FIELD

Aspects of the present disclosure relate generally to wireless communication systems, and more particularly, to precoding operations. Certain embodiments of the technology discussed below can enable and provide reduced power operation and increased throughput.

### INTRODUCTION

Wireless communication networks are widely deployed to provide various communication services such as voice, video, packet data, messaging, broadcast, and the like. These wireless networks may be multiple-access networks capable of supporting multiple users by sharing the available network resources. Such networks, which are usually multiple access networks, support communications for multiple users by sharing the available network resources.

A wireless communication network may include a number of base stations or node Bs that can support communication for a number of user equipments (UEs). A UE may communicate with a base station via downlink and uplink. The downlink (or forward link) refers to the communication link from the base station to the UE, and the uplink (or reverse link) refers to the communication link from the UE to the base station.

A base station may transmit data and control information on the downlink to a UE and/or may receive data and control information on the uplink from the UE. On the downlink, a transmission from the base station may encounter interference due to transmissions from neighbor base stations or from other wireless radio frequency (RF) transmitters. On the uplink, a transmission from the UE may encounter interference from uplink transmissions of other UEs communicating with the neighbor base stations or from other wireless RF transmitters. This interference may degrade performance on both the downlink and uplink.

As the demand for mobile broadband access continues to increase, the possibilities of interference and congested networks grows with more UEs accessing the long-range wireless communication networks and more short-range wireless systems being deployed in communities. Research and development continue to advance wireless technologies not only to meet the growing demand for mobile broadband access, but to advance and enhance the user experience with mobile communications.

### BRIEF SUMMARY OF SOME EMBODIMENTS

The following summarizes some aspects of the present disclosure to provide a basic understanding of the discussed technology. This summary is not an extensive overview of all contemplated features of the disclosure, and is intended neither to identify key or critical elements of all aspects of the disclosure nor to delineate the scope of any or all aspects of the disclosure. Its sole purpose is to present some concepts of one or more aspects of the disclosure in summary form as a prelude to the more detailed description that is presented later.

The described techniques relate to improved methods, systems, devices, and apparatuses that support enhanced precoding procedures, including transmitting updated precoding information. For example, a user equipment (UE) may track updates to precoding information based on UE mobility. The UE may generate precoding information updates based on the mobility of the UE and may transmit the precoding information updates to a host node (e.g., base station) more frequently. To illustrate, a UE may generate changes in precoding information relative to previous precoding information, referred to as delta precoding information and may send the delta precoding information prior to generation new precoding information in a channel report, such as in an acknowledgment message. By transmitting precoding information updates throughput and reliability may be increased without increasing network overhead. Accordingly, such techniques may also be used to decrease network overhead.

In one aspect of the disclosure, a method of wireless communication includes generating, by a user equipment (UE), a delta precoding value for a precoding matrix update, the delta precoding value relative to a previous precoding matrix. The method also includes generating, by the UE, a delta power loading value for the precoding matrix update, the delta power loading value relative to the previous precoding matrix. The method further includes transmitting, by the UE, a transmission indicating the delta precoding value and the delta power loading value.

In another aspect, an apparatus configured for wireless communication includes at least one processor and a memory coupled to the processor. The processor is configured: to generate, by a user equipment (UE), a delta precoding value for a precoding matrix update, the delta precoding value relative to a previous precoding matrix; to generate, by the UE, a delta power loading value for the precoding matrix update, the delta power loading value relative to the previous precoding matrix; and to transmit, by the UE, a transmission indicating the delta precoding value and the delta power loading value.

In an additional aspect, a method of wireless communication includes receiving, by a network device, a transmission indicating a delta precoding value and a delta power loading value for a precoding matrix, the delta precoding value and the delta power loading value relative to a previous precoding matrix. The method also includes updating, by the network device, the previous precoding matrix based on the delta precoding value and the delta power loading value to generate an updated precoding matrix. The method further includes transmitting, by the network device, a data transmission based on the updated precoding matrix.

In another aspect, an apparatus configured for wireless communication includes at least one processor and a memory coupled to the processor. The processor is configured: to receive, by a network device, a transmission indicating a delta precoding value and a delta power loading value for a precoding matrix, the delta precoding value and the delta power loading value relative to a previous precoding matrix; to update, by the network device, the previous precoding matrix based on the delta precoding value and the delta power loading value to generate an updated precoding matrix; and to transmit, by the network device, a data transmission based on the updated precoding matrix.

In an additional aspect, a method of wireless communication includes generating, by a user equipment (UE), a delta precoding value for a precoding matrix, the delta precoding value relative to a previous precoding matrix; and transmitting, by the UE, a transmission indicating the delta precoding value.

In an additional aspect, a method of wireless communication includes generating, by a user equipment (UE), a delta power loading value for a precoding matrix, the delta power loading value relative to a previous precoding matrix; and transmitting, by the UE, a transmission indicating the delta power loading value.

In an additional aspect, a method of wireless communication includes generating, by a user equipment (UE), precoding update for a precoding matrix indicated in channel state feedback based on a downlink transmission; and transmitting, by the UE, a transmission indicating the precoding update.

Other aspects, features, and embodiments will become apparent to those of ordinary skill in the art, upon reviewing the following description of specific, exemplary embodiments in conjunction with the accompanying figures. While features may be discussed relative to certain embodiments and figures below, all embodiments can include one or more of the advantageous features discussed herein. In other words, while one or more embodiments may be discussed as having certain advantageous features, one or more of such features may also be used in accordance with the various embodiments. In similar fashion, while exemplary embodiments may be discussed below as device, system, or method embodiments the exemplary embodiments can be implemented in various devices, systems, and methods.

### BRIEF DESCRIPTION OF THE DRAWINGS

A further understanding of the nature and advantages of the present disclosure may be realized by reference to the following drawings. In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label.

FIG. 1 is a block diagram illustrating details of a wireless communication system according to some embodiments of the present disclosure.

FIG. 2 is a block diagram conceptually illustrating a design of a base station and a UE configured according to some embodiments of the present disclosure.

FIG. 3 is a ladder diagram of an example of channel state feedback operations.

FIG. 4 is a block diagram illustrating an example of a wireless communications system (with a UE and base station) with precoding information updates.

FIG. 5 is a diagram of an example of a ladder diagram of precoding information update according to some embodiments of the present disclosure.

FIG. 6 is a diagram of another example of a ladder diagram of precoding information update according to some embodiments of the present disclosure.

FIG. 7 is a diagram of channel correlation to channel feedback over time.

FIG. 8 is a diagram of channel correlation to channel feedback over time.

FIG. 9 is a diagram illustrating an example of precoding update information.

FIGS. 10A and 10B are diagrams illustrating examples of additional layer precoding.

FIG. 11 is a flow diagram illustrating example blocks executed by a UE configured according to an aspect of the present disclosure.

FIG. 12 is a flow diagram illustrating example blocks executed by a base station configured according to an aspect of the present disclosure.

FIG. 13 is a block diagram conceptually illustrating a design of a UE configured to perform precoding information update operations according to some embodiments of the present disclosure.

FIG. 14 is a block diagram conceptually illustrating a design of a base station configured to perform precoding information update operations according to some embodiments of the present disclosure.

### DETAILED DESCRIPTION

The present disclosure is related to precoding operations for wireless communications. Precoding, such as by a precoding matrix which is indicated by a precoding matrix identifier, is used to match uplink and downlink beams to improve throughput and reliability. Conventionally, channel state feedback (CSF) operations may be used to communicate precoding matrix information. For example, a node (e.g., base station) may periodically send out pilot signals, such as CSI-RS. The nodes (e.g., user equipments (UEs)) monitor the CSI-RS transmissions to estimate one or more channels of the link between the UE and the hose node. The UE may determine a Rank Indicator (RI), a Channel Quality Indicator (CQI), and a Precoding Matrix Identifier (PMI). The UE may indicate such parameters by responding to the host node with a channel report, such as a CSF, CSI, or CQI report. Such operations are repeated periodically, such as every 20 or 80 milliseconds, and the narrow beam nature of 5G and mobile environment may dictate even shorter periods.

However, when performing such conventional precoding and beam management operations, overhead increases and device mobility can cause issues. For example, if a device moves in between updates (i.e., during the 80 milliseconds) throughput and reliability are reduced. Additionally. performing the updates every 80 milliseconds and increasing the update frequency adds network overhead, which reduces throughput and latency. Thus, a large portion of bandwidth is dedicated to precoding operations/matching for beam management.

The described techniques relate to improved methods, systems, devices, and apparatuses that support the use of layer precoding. Layer precoding involves updating the precoding information in between the conventional transmission of precoding information in channel reports. For example, a user equipment (UE) may generate updated precoding information in between channel reports and transmit such information to a base station.

By transmitting updated and more accurate precoding information, a bandwidth consumed by the precoding may be reduced and/or throughput and reliability are increased. Additionally, or alternatively, less complex demapping/decoding operations may be performed and/or less sophisticated. Accordingly, such techniques may also decrease processing times, reduce device size, and/or reduce power consumption.

The detailed description set forth below, in connection with the appended drawings and appendix, is intended as a description of various configurations and is not intended to limit the scope of the disclosure. Rather, the detailed description includes specific details for the purpose of providing a thorough understanding of the inventive subject matter. It will be apparent to those skilled in the art that these specific details are not required in every case and that, in some instances, well-known structures and components are shown in block diagram form for clarity of presentation.

This disclosure relates generally to providing or participating in communication as between two or more wireless devices in one or more wireless communications systems, also referred to as wireless communications networks. In various embodiments, the techniques and apparatus may be used for wireless communication networks such as code division multiple access (CDMA) networks, time division multiple access (TDMA) networks, frequency division multiple access (FDMA) networks, orthogonal FDMA (OFDMA) networks, single-carrier FDMA (SC-FDMA) networks, LTE networks, GSM networks, 5^{th} Generation (5G) or new radio (NR) networks (sometimes referred to as “5G NR” networks/systems/devices), as well as other communications networks. As described herein, the terms “networks” and “systems” may be used interchangeably.

A CDMA network, for example, may implement a radio technology such as universal terrestrial radio access (UTRA), cdma2000, and the like. UTRA includes wideband-CDMA (W-CDMA) and low chip rate (LCR). CDMA2000 covers IS-2000, IS-95, and IS-856 standards.

A TDMA network may, for example implement a radio technology such as GSM. 3GPP defines standards for the GSM EDGE (enhanced data rates for GSM evolution) radio access network (RAN), also denoted as GERAN. GERAN is the radio component of GSM/EDGE, together with the network that joins the base stations (for example, the Ater and Abis interfaces) and the base station controllers (A interfaces, etc.). The radio access network represents a component of a GSM network, through which phone calls and packet data are routed from and to the public switched telephone network (PSTN) and Internet to and from subscriber handsets, also known as user terminals or user equipments (UEs). A mobile phone operator's network may comprise one or more GERANs, which may be coupled with Universal Terrestrial Radio Access Networks (UTRANs) in the case of a UMTS/GSM network. An operator network may also include one or more LTE networks, and/or one or more other networks. The various different network types may use different radio access technologies (RATs) and radio access networks (RANs).

An OFDMA network may implement a radio technology such as evolved UTRA (E-UTRA), IEEE 802.11, IEEE 802.16, IEEE 802.20, flash-OFDM and the like. UTRA, E-UTRA, and Global System for Mobile Communications (GSM) are part of universal mobile telecommunication system (UMTS). In particular, long term evolution (LTE) is a release of UMTS that uses E-UTRA. UTRA, E-UTRA, GSM, UMTS and LTE are described in documents provided from an organization named “3rd Generation Partnership Project” (3GPP), and cdma2000 is described in documents from an organization named “3rd Generation Partnership Project 2” (3GPP2). These various radio technologies and standards are known or are being developed. For example, the 3rd Generation Partnership Project (3GPP) is a collaboration between groups of telecommunications associations that aims to define a globally applicable third generation (3G) mobile phone specification. 3GPP long term evolution (LTE) is a 3GPP project which was aimed at improving the universal mobile telecommunications system (UMTS) mobile phone standard. The 3GPP may define specifications for the next generation of mobile networks, mobile systems, and mobile devices. The present disclosure is concerned with the evolution of wireless technologies from LTE, 4G, 5G, NR, and beyond with shared access to wireless spectrum between networks using a collection of new and different radio access technologies or radio air interfaces.

5G networks contemplate diverse deployments, diverse spectrum, and diverse services and devices that may be implemented using an OFDM-based unified, air interface. To achieve these goals, further enhancements to LTE and LTE-A are considered in addition to development of the new radio technology for 5G NR networks. The 5G NR will be capable of scaling to provide coverage (1) to a massive Internet of things (IoTs) with an ultra-high density (e.g., ˜1M nodes/km²), ultra-low complexity (e.g., ˜10 s of bits/sec), ultra-low energy (e.g., ˜10+ years of battery life), and deep coverage with the capability to reach challenging locations; (2) including mission-critical control with strong security to safeguard sensitive personal, financial, or classified information, ultra-high reliability (e.g., ˜99.9999% reliability), ultra-low latency (e.g., ˜1 ms), and users with wide ranges of mobility or lack thereof; and (3) with enhanced mobile broadband including extreme high capacity (e.g., ˜10 Tbps/km²), extreme data rates (e.g., multi-Gbps rate, 100+ Mbps user experienced rates), and deep awareness with advanced discovery and optimizations.

5G NR devices, networks, and systems may be implemented to use optimized OFDM-based waveform features. These features may include scalable numerology and transmission time intervals (TTIs); a common, flexible framework to efficiently multiplex services and features with a dynamic, low-latency time division duplex (TDD)/frequency division duplex (FDD) design; and advanced wireless technologies, such as massive multiple input, multiple output (MIMO), robust millimeter wave (mmWave) transmissions, advanced channel coding, and device-centric mobility. Scalability of the numerology in 5G NR, with scaling of subcarrier spacing, may efficiently address operating diverse services across diverse spectrum and diverse deployments. For example, in various outdoor and macro coverage deployments of less than 3 GHz FDD/TDD implementations, subcarrier spacing may occur with 15 kHz, for example over 1, 5, 10, 20 MHz, and the like bandwidth. For other various outdoor and small cell coverage deployments of TDD greater than 3 GHz, subcarrier spacing may occur with 30 kHz over 80/100 MHz bandwidth. For other various indoor wideband implementations, using a TDD over the unlicensed portion of the 5 GHz band, the subcarrier spacing may occur with 60 kHz over a 160 MHz bandwidth. Finally, for various deployments transmitting with mmWave components at a TDD of 28 GHz, subcarrier spacing may occur with 120 kHz over a 500 MHz bandwidth.

The scalable numerology of 5G NR facilitates scalable TTI for diverse latency and quality of service (QoS) requirements. For example, shorter TTI may be used for low latency and high reliability, while longer TTI may be used for higher spectral efficiency. The efficient multiplexing of long and short TTIs to allow transmissions to start on symbol boundaries. 5G NR also contemplates a self-contained integrated subframe design with uplink/downlink scheduling information, data, and acknowledgement in the same subframe. The self-contained integrated subframe supports communications in unlicensed or contention-based shared spectrum, adaptive uplink/downlink that may be flexibly configured on a per-cell basis to dynamically switch between uplink and downlink to meet the current traffic needs.

For clarity, certain aspects of the apparatus and techniques may be described below with reference to exemplary LTE implementations or in an LTE-centric way, and LTE terminology may be used as illustrative examples in portions of the description below; however, the description is not intended to be limited to LTE applications. Indeed, the present disclosure is concerned with shared access to wireless spectrum between networks using different radio access technologies or radio air interfaces, such as those of 5G NR.

Moreover, it should be understood that, in operation, wireless communication networks adapted according to the concepts herein may operate with any combination of licensed or unlicensed spectrum depending on loading and availability. Accordingly, it will be apparent to one of skill in the art that the systems, apparatus and methods described herein may be applied to other communications systems and applications than the particular examples provided.

While aspects and embodiments are described in this application by illustration to some examples, those skilled in the art will understand that additional implementations and use cases may come about in many different arrangements and scenarios. Innovations described herein may be implemented across many differing platform types, devices, systems, shapes, sizes, packaging arrangements. For example, embodiments and/or uses may come about via integrated chip embodiments and/or other non-module-component based devices (e.g., end-user devices, vehicles, communication devices, computing devices, industrial equipment, retail/purchasing devices, medical devices, AI-enabled devices, etc.). While some examples may or may not be specifically directed to use cases or applications, a wide assortment of applicability of described innovations may occur. Implementations may range from chip-level or modular components to non-modular, non-chip-level implementations and further to aggregated, distributed, or OEM devices or systems incorporating one or more described aspects. In some practical settings, devices incorporating described aspects and features may also necessarily include additional components and features for implementation and practice of claimed and described embodiments. It is intended that innovations described herein may be practiced in a wide variety of implementations, including both large/small devices, chip-level components, multi-component systems (e.g. RF-chain, communication interface, processor), distributed arrangements, end-user devices, etc. of varying sizes, shapes, and constitution.

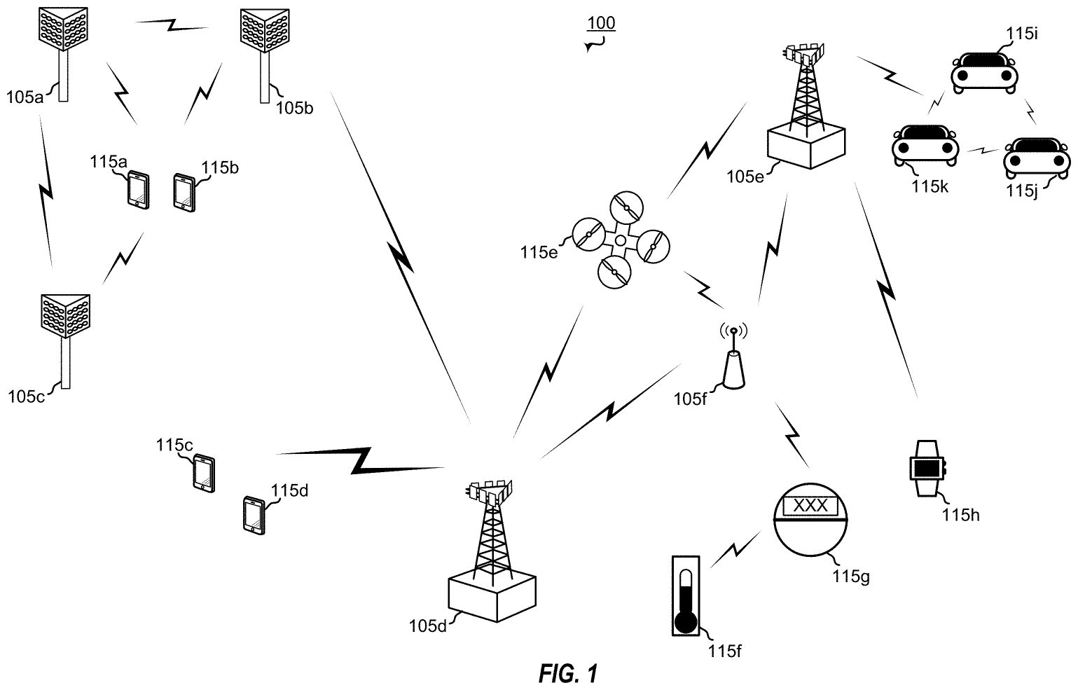

FIG. 1 shows wireless network 100 for communication according to some embodiments. Wireless network 100 may, for example, comprise a 5G wireless network. As appreciated by those skilled in the art, components appearing in FIG. 1 are likely to have related counterparts in other network arrangements including, for example, cellular-style network arrangements and non-cellular-style-network arrangements (e.g., device to device or peer to peer or ad hoc network arrangements, etc.).

Wireless network 100 illustrated in FIG. 1 includes a number of base stations 105 and other network entities. A base station may be a station that communicates with the UEs and may also be referred to as an evolved node B (eNB), a next generation eNB (gNB), an access point, and the like. Each base station 105 may provide communication coverage for a particular geographic area. In 3GPP, the term “cell” can refer to this particular geographic coverage area of a base station and/or a base station subsystem serving the coverage area, depending on the context in which the term is used. In implementations of wireless network 100 herein, base stations 105 may be associated with a same operator or different operators (e.g., wireless network 100 may comprise a plurality of operator wireless networks), and may provide wireless communications using one or more of the same frequencies (e.g., one or more frequency bands in licensed spectrum, unlicensed spectrum, or a combination thereof) as a neighboring cell. In some examples, an individual base station 105 or UE 115 may be operated by more than one network operating entity. In other examples, each base station 105 and UE 115 may be operated by a single network operating entity.

A base station may provide communication coverage for a macro cell or a small cell, such as a pico cell or a femto cell, and/or other types of cell. A macro cell generally covers a relatively large geographic area (e.g., several kilometers in radius) and may allow unrestricted access by UEs with service subscriptions with the network provider. A small cell, such as a pico cell, would generally cover a relatively smaller geographic area and may allow unrestricted access by UEs with service subscriptions with the network provider. A small cell, such as a femto cell, would also generally cover a relatively small geographic area (e.g., a home) and, in addition to unrestricted access, may also provide restricted access by UEs having an association with the femto cell (e.g., UEs in a closed subscriber group (CSG), UEs for users in the home, and the like). A base station for a macro cell may be referred to as a macro base station. A base station for a small cell may be referred to as a small cell base station, a pico base station, a femto base station or a home base station. In the example shown in FIG. 1, base stations 105d and 105e are regular macro base stations, while base stations 105a-105c are macro base stations enabled with one of 3 dimension (3D), full dimension (FD), or massive MIMO. Base stations 105a-105c take advantage of their higher dimension MIMO capabilities to exploit 3D beamforming in both elevation and azimuth beamforming to increase coverage and capacity. Base station 105f is a small cell base station which may be a home node or portable access point. A base station may support one or multiple (e.g., two, three, four, and the like) cells.

Wireless network 100 may support synchronous or asynchronous operation. For synchronous operation, the base stations may have similar frame timing, and transmissions from different base stations may be approximately aligned in time. For asynchronous operation, the base stations may have different frame timing, and transmissions from different base stations may not be aligned in time. In some scenarios, networks may be enabled or configured to handle dynamic switching between synchronous or asynchronous operations.

UEs 115 are dispersed throughout the wireless network 100, and each UE may be stationary or mobile. It should be appreciated that, although a mobile apparatus is commonly referred to as user equipment (UE) in standards and specifications promulgated by the 3rd Generation Partnership Project (3GPP), such apparatus may also be referred to by those skilled in the art as a mobile station (MS), a subscriber station, a mobile unit, a subscriber unit, a wireless unit, a remote unit, a mobile device, a wireless device, a wireless communications device, a remote device, a mobile subscriber station, an access terminal (AT), a mobile terminal, a wireless terminal, a remote terminal, a handset, a terminal, a user agent, a mobile client, a client, or some other suitable terminology. Within the present document, a “mobile” apparatus or UE need not necessarily have a capability to move, and may be stationary. Some non-limiting examples of a mobile apparatus, such as may comprise embodiments of one or more of UEs 115, include a mobile, a cellular (cell) phone, a smart phone, a session initiation protocol (SIP) phone, a wireless local loop (WLL) station, a laptop, a personal computer (PC), a notebook, a netbook, a smart book, a tablet, and a personal digital assistant (PDA). A mobile apparatus may additionally be an “Internet of things” (IoT) or “Internet of everything” (IoE) device such as an automotive or other transportation vehicle, a satellite radio, a global positioning system (GPS) device, a logistics controller, a drone, a multi-copter, a quad-copter, a smart energy or security device, a solar panel or solar array, municipal lighting, water, or other infrastructure; industrial automation and enterprise devices; consumer and wearable devices, such as eyewear, a wearable camera, a smart watch, a health or fitness tracker, a mammal implantable device, gesture tracking device, medical device, a digital audio player (e.g., MP3 player), a camera, a game console, etc.; and digital home or smart home devices such as a home audio, video, and multimedia device, an appliance, a sensor, a vending machine, intelligent lighting, a home security system, a smart meter, etc. In one aspect, a UE may be a device that includes a Universal Integrated Circuit Card (UICC). In another aspect, a UE may be a device that does not include a UICC. In some aspects, UEs that do not include UICCs may also be referred to as IoE devices. UEs 115a-115d of the embodiment illustrated in FIG. 1 are examples of mobile smart phone-type devices accessing wireless network 100 A UE may also be a machine specifically configured for connected communication, including machine type communication (MTC), enhanced MTC (eMTC), narrowband IoT (NB-IoT) and the like. UEs 115e-115k illustrated in FIG. 1 are examples of various machines configured for communication that access wireless network 100.

A mobile apparatus, such as UEs 115, may be able to communicate with any type of the base stations, whether macro base stations, pico base stations, femto base stations, relays, and the like. In FIG. 1, a lightning bolt (e.g., communication link) indicates wireless transmissions between a UE and a serving base station, which is a base station designated to serve the UE on the downlink and/or uplink, or desired transmission between base stations, and backhaul transmissions between base stations. Backhaul communication between base stations of wireless network 100 may occur using wired and/or wireless communication links.

In operation at wireless network 100, base stations 105a-105c serve UEs 115a and 115b using 3D beamforming and coordinated spatial techniques, such as coordinated multipoint (CoMP) or multi-connectivity. Macro base station 105d performs backhaul communications with base stations 105a-105c, as well as small cell, base station 105f Macro base station 105d also transmits multicast services which are subscribed to and received by UEs 115c and 115d. Such multicast services may include mobile television or stream video, or may include other services for providing community information, such as weather emergencies or alerts, such as Amber alerts or gray alerts.

Wireless network 100 of embodiments supports mission critical communications with ultra-reliable and redundant links for mission critical devices, such UE 115e, which is a drone. Redundant communication links with UE 115e include from macro base stations 105d and 105e, as well as small cell base station 105f. Other machine type devices, such as UE 115f (thermometer), UE 115g (smart meter), and UE 115h (wearable device) may communicate through wireless network 100 either directly with base stations, such as small cell base station 105f, and macro base station 105e, or in multi-hop configurations by communicating with another user device which relays its information to the network, such as UE 115f communicating temperature measurement information to the smart meter, UE 115g, which is then reported to the network through small cell base station 105f. Wireless network 100 may also provide additional network efficiency through dynamic, low-latency TDD/FDD communications, such as in a vehicle-to-vehicle (V2V) mesh network between UEs 115i-115k communicating with macro base station 105e.

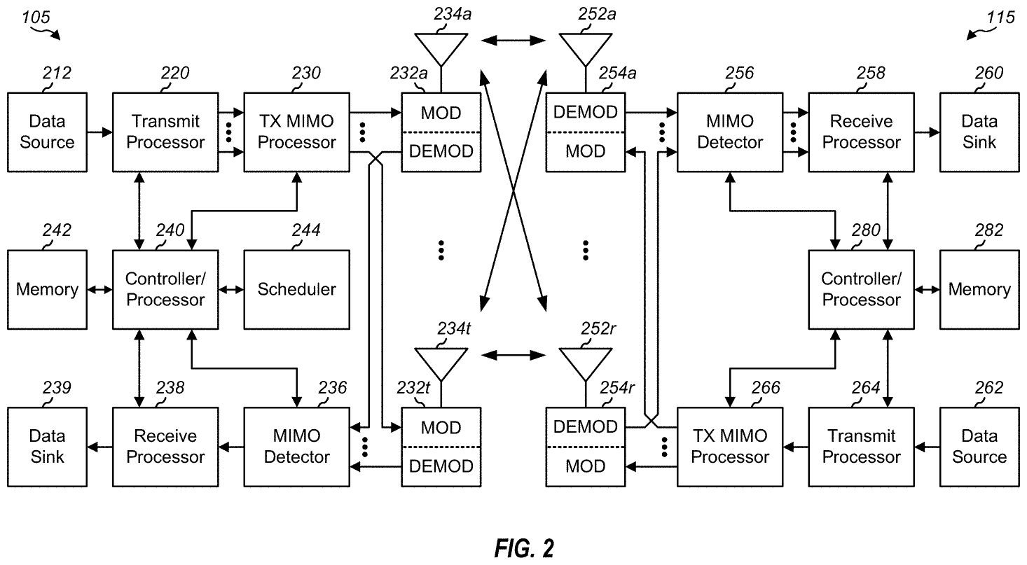

FIG. 2 shows a block diagram of a design of a base station 105 and a UE 115, which may be any of the base stations and one of the UEs in FIG. 1. For a restricted association scenario (as mentioned above), base station 105 may be small cell base station 105f in FIG. 1, and UE 115 may be UE 115c or 115D operating in a service area of base station 105f, which in order to access small cell base station 105f, would be included in a list of accessible UEs for small cell base station 105f. Base station 105 may also be a base station of some other type. As shown in FIG. 2, base station 105 may be equipped with antennas 234a through 234t, and UE 115 may be equipped with antennas 252a through 252r for facilitating wireless communications.

At the base station 105, a transmit processor 220 may receive data from a data source 212 and control information from a controller/processor 240. The control information may be for the physical broadcast channel (PBCH), physical control format indicator channel (PCFICH), physical hybrid-ARQ (automatic repeat request) indicator channel (PHICH), physical downlink control channel (PDCCH), enhanced physical downlink control channel (EPDCCH), MTC physical downlink control channel (MPDCCH), etc. The data may be for the PDSCH, etc. The transmit processor 220 may process (e.g., encode and symbol map) the data and control information to obtain data symbols and control symbols, respectively. The transmit processor 220 may also generate reference symbols, e.g., for the primary synchronization signal (PSS) and secondary synchronization signal (SSS), and cell-specific reference signal. Transmit (TX) multiple-input multiple-output (MIMO) processor 230 may perform spatial processing (e.g., precoding) on the data symbols, the control symbols, and/or the reference symbols, if applicable, and may provide output symbol streams to modulators (MODs) 232a through 232t. Each modulator 232 may process a respective output symbol stream (e.g., for OFDM, etc.) to obtain an output sample stream. Each modulator 232 may additionally or alternatively process (e.g., convert to analog, amplify, filter, and upconvert) the output sample stream to obtain a downlink signal. Downlink signals from modulators 232a through 232t may be transmitted via the antennas 234a through 234t, respectively.

At the UE 115, the antennas 252a through 252r may receive the downlink signals from the base station 105 and may provide received signals to the demodulators (DEMODs) 254a through 254r, respectively. Each demodulator 254 may condition (e.g., filter, amplify, downconvert, and digitize) a respective received signal to obtain input samples. Each demodulator 254 may further process the input samples (e.g., for OFDM, etc.) to obtain received symbols. MIMO detector 256 may obtain received symbols from demodulators 254a through 254r, perform MIMO detection on the received symbols if applicable, and provide detected symbols. Receive processor 258 may process (e.g., demodulate, deinterleave, and decode) the detected symbols, provide decoded data for the UE 115 to a data sink 260, and provide decoded control information to a controller/processor 280.

On the uplink, at the UE 115, a transmit processor 264 may receive and process data (e.g., for the physical uplink shared channel (PUSCH)) from a data source 262 and control information (e.g., for the physical uplink control channel (PUCCH)) from the controller/processor 280. Transmit processor 264 may also generate reference symbols for a reference signal. The symbols from the transmit processor 264 may be precoded by TX MIMO processor 266 if applicable, further processed by the modulators 254a through 254r (e.g., for SC-FDM, etc.), and transmitted to the base station 105. At base station 105, the uplink signals from UE 115 may be received by antennas 234, processed by demodulators 232, detected by MIMO detector 236 if applicable, and further processed by receive processor 238 to obtain decoded data and control information sent by UE 115. Processor 238 may provide the decoded data to data sink 239 and the decoded control information to controller/processor 240.

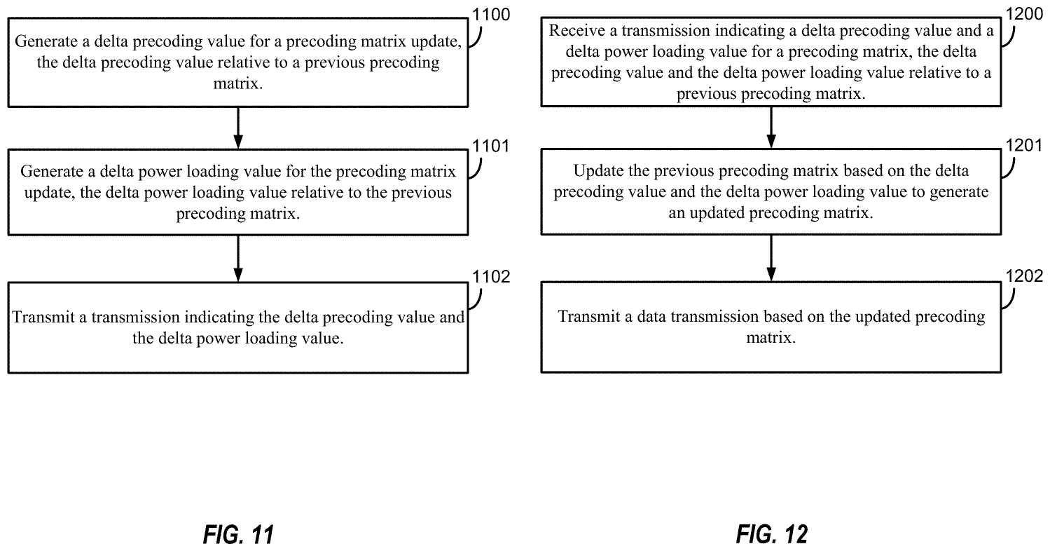

Controllers/processors 240 and 280 may direct the operation at base station 105 and UE 115, respectively. Controller/processor 240 and/or other processors and modules at base station 105 and/or controller/processor 28 and/or other processors and modules at UE 115 may perform or direct the execution of various processes for the techniques described herein, such as to perform or direct the execution illustrated in FIGS. 11 and 12, and/or other processes for the techniques described herein. Memories 242 and 282 may store data and program codes for base station 105 and UE 115, respectively. Scheduler 244 may schedule UEs for data transmission on the downlink and/or uplink.

Wireless communications systems operated by different network operating entities (e.g., network operators) may share spectrum. In some instances, a network operating entity may be configured to use an entirety of a designated shared spectrum for at least a period of time before another network operating entity uses the entirety of the designated shared spectrum for a different period of time. Thus, in order to allow network operating entities use of the full designated shared spectrum, and in order to mitigate interfering communications between the different network operating entities, certain resources (e.g., time) may be partitioned and allocated to the different network operating entities for certain types of communication.

For example, a network operating entity may be allocated certain time resources reserved for exclusive communication by the network operating entity using the entirety of the shared spectrum. The network operating entity may also be allocated other time resources where the entity is given priority over other network operating entities to communicate using the shared spectrum. These time resources, prioritized for use by the network operating entity, may be utilized by other network operating entities on an opportunistic basis if the prioritized network operating entity does not utilize the resources. Additional time resources may be allocated for any network operator to use on an opportunistic basis.

Access to the shared spectrum and the arbitration of time resources among different network operating entities may be centrally controlled by a separate entity, autonomously determined by a predefined arbitration scheme, or dynamically determined based on interactions between wireless nodes of the network operators.

In some cases, UE 115 and base station 105 may operate in a shared radio frequency spectrum band, which may include licensed or unlicensed (e.g., contention-based) frequency spectrum. In an unlicensed frequency portion of the shared radio frequency spectrum band, UEs 115 or base stations 105 may traditionally perform a medium-sensing procedure to contend for access to the frequency spectrum. For example, UE 115 or base station 105 may perform a listen before talk (LBT) procedure such as a clear channel assessment (CCA) prior to communicating in order to determine whether the shared channel is available. A CCA may include an energy detection procedure to determine whether there are any other active transmissions. For example, a device may infer that a change in a received signal strength indicator (RSSI) of a power meter indicates that a channel is occupied. Specifically, signal power that is concentrated in a certain bandwidth and exceeds a predetermined noise floor may indicate another wireless transmitter. A CCA also may include detection of specific sequences that indicate use of the channel. For example, another device may transmit a specific preamble prior to transmitting a data sequence. In some cases, an LBT procedure may include a wireless node adjusting its own backoff window based on the amount of energy detected on a channel and/or the acknowledge/negative-acknowledge (ACK/NACK) feedback for its own transmitted packets as a proxy for collisions.

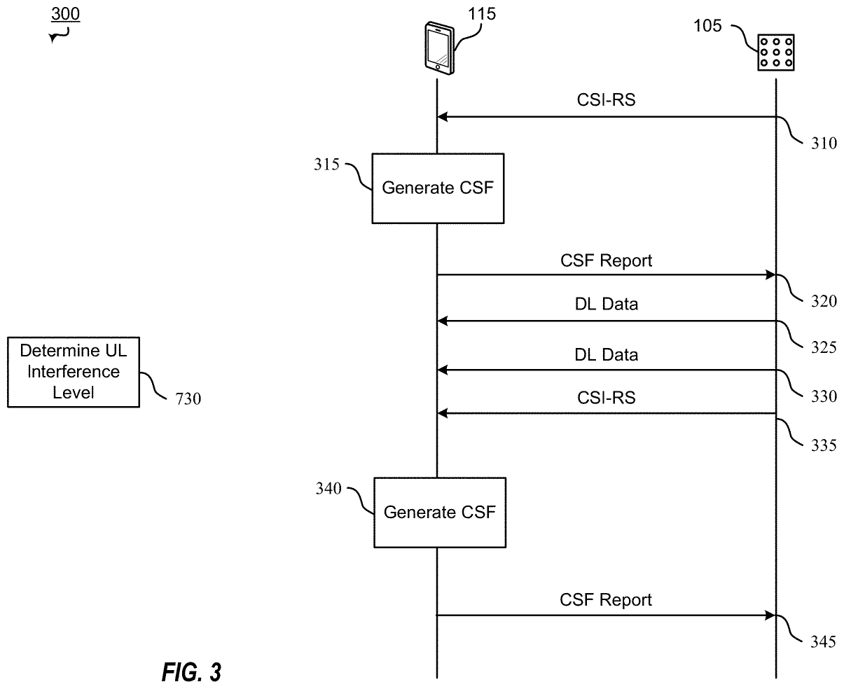

FIG. 3 illustrates an example ladder diagram 300 for conventional channel state feedback operations. Referring to FIG. 3, the ladder diagram 300 illustrates one full channel state feedback cycle between a UE and a base station.

At 310, base station 105 generates and transmits a CSI-RS. For example, the base station 105 sends a CSI-RS, pilot signal, to be used for estimating channel conditions and providing channel state feedback. The base station 105 may generate such a CSI-RS periodically, such as every 20 to 80 milliseconds.

At 315, UE 115 generates channel state feedback (CSF) based on the CSI-RS. For example, the UE 115 estimates channel conditions based on the CSI-RS. To illustrate, the UE 115 generates one or more of a rank indicator (RI), a channel quality indicator (CQI), or a precoding matrix identifier (PMI).

At 320, UE 115 generates and transmits a CSF report based on the CSF. For example, the UE 115 includes one or more of the RI, the CQI, or the PMI in the CSF report.

At 325, the base station 105 generates and transmits first downlink data. For example, the base station 105 transmits a first PDSCH transmission generated based on the CSF report. To illustrate, the base station 105 precodes the transmission based on the PMI.

At 330, the base station 105 generates and transmits second downlink data. For example, the base station 105 transmits a second PDSCH transmission generated based on the CSF report. To illustrate, the base station 105 precodes the transmission based on the PMI.

At 335, the base station 105 generates and transmits a second CSI-RS. For example, the base station 105 sends a CSI-RS, pilot signal, to be used for estimating channel conditions and providing channel state feedback.

At 340, UE 115 generates second channel state feedback (CSF) based on the CSI-RS. For example, the UE 115 estimates channel conditions based on the CSI-RS. To illustrate, the UE 115 generates one or more of a second rank indicator (RI), a second channel quality indicator (CQI), or a second precoding matrix identifier (PMI).

At 345, UE 115 generates and transmits a second CSF report based on the second CSF. For example, the UE 115 includes one or more of the second RI, the second CQI, or the second PMI in the second CSF report.

At 350, the base station 105 generates and transmits third downlink data. For example, the base station 105 transmits a third PDSCH transmission generated based on the second CSF report. To illustrate, the base station 105 precodes the transmission based on the second PMI.

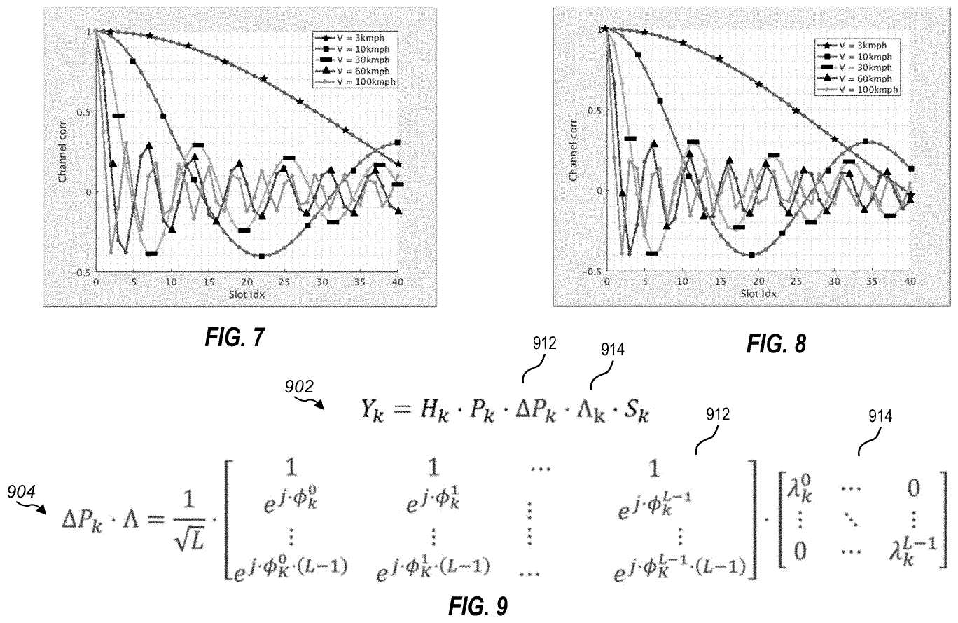

In the example illustrated in FIG. 3, generally the correlation of the CSF to the second PDSCH is lower than the correlation of the CSF to the first PDSCH because more time has elapsed since the channel conditions were estimated. One factor in such degradation is device mobility, and such effects are shown and described further with reference to FIGS. 7 and 8. Thus, throughput and reliability may degrade for transmissions that occur between CSF reporting, and increasing the CSF reporting (e.g., decreasing periodicity) will increase network overhead.

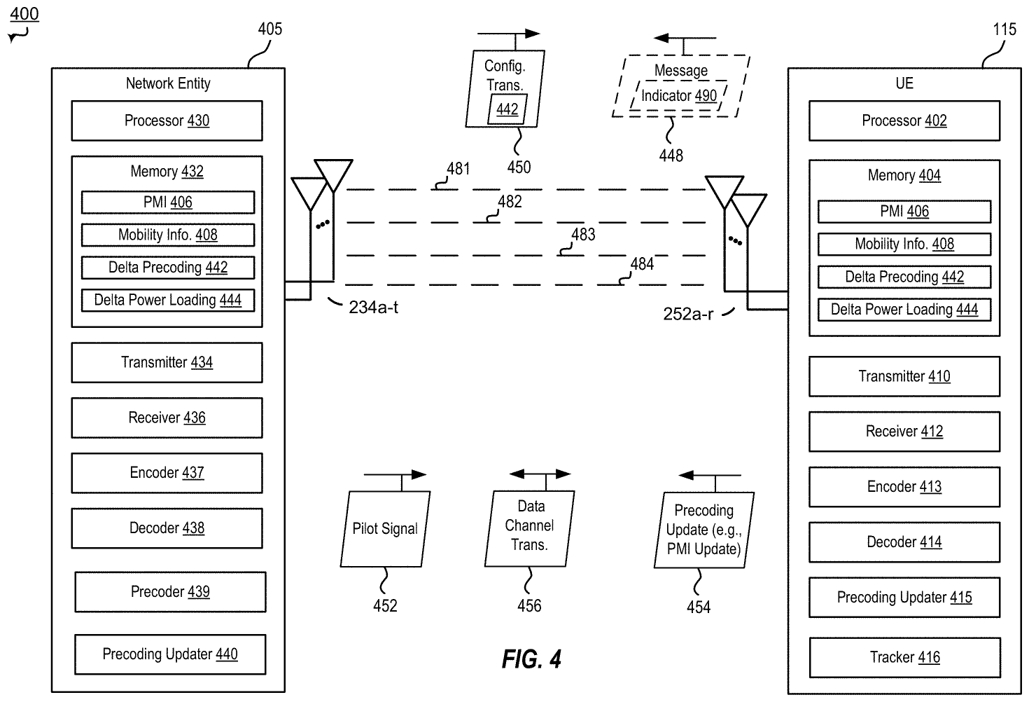

FIG. 4 illustrates an example of a wireless communications system 400 that supports precoding updates in accordance with aspects of the present disclosure. In some examples, wireless communications system 400 may implement aspects of wireless communication system 100. For example, wireless communications system 400 may include UE 115 and network entity 405. Precoding update operations may increase throughput and reliability by updating precoding information more often, and thus may reduce network overhead. Additionally, in some implementations, the precoding updates may be performed with the existing network framework, such as with already sent pilot signals (e.g., PDSCH DMRS) and provided back with acknowledgement messages.

Network entity 405 and UE 115 UE 115 may be configured to communicate via frequency bands, such as FR1 having a frequency of 410 to 7125 MHz or FR2 having a frequency of 24250 to 52600 MHz for mm-Wave. It is noted that sub-carrier spacing (SCS) may be equal to 15, 30, 60, or 120 kHz for some data channels. Network entity 405 and UE 115 may be configured to communicate via one or more component carriers (CCs), such as representative first CC 481, second CC 482, third CC 483, and fourth CC 484. Although four CCs are shown, this is for illustration only, more or fewer than four CCs may be used. One or more CCs may be used to communicate control channel transmissions, data channel transmissions, and/or sidelink channel transmissions.

Such transmissions may include a Physical Downlink Control Channel (PDCCH), a Physical Downlink Shared Channel (PDSCH), a Physical Uplink Control Channel (PUCCH), a Physical Uplink Shared Channel (PUSCH), a Physical Sidelink Control Channel (PSCCH), a Physical Sidelink Shared Channel (PSSCH), or a Physical Sidelink Feedback Channel (PSFCH). Such transmissions may be scheduled by aperiodic grants and/or periodic grants.

Each periodic grant may have a corresponding configuration, such as configuration parameters/settings. The periodic grant configuration may include configured grant (CG) configurations and settings. Additionally, or alternatively, one or more periodic grants (e.g., CGs thereof) may have or be assigned to a CC ID, such as intended CC ID.

Each CC may have a corresponding configuration, such as configuration parameters/settings. The configuration may include bandwidth, bandwidth part, HARQ process, TCI state, RS, control channel resources, data channel resources, or a combination thereof. Additionally, or alternatively, one or more CCs may have or be assigned to a Cell ID, a Bandwidth Part (BWP) ID, or both. The Cell ID may include a unique cell ID for the CC, a virtual Cell ID, or a particular Cell ID of a particular CC of the plurality of CCs. Additionally, or alternatively, one or more CCs may have or be assigned to a HARQ ID. Each CC may also have corresponding management functionalities, such as, beam management, BWP switching functionality, or both. In some implementations, two or more CCs are quasi co-located, such that the CCs have the same beam and/or same symbol.

In some implementations, control information may be communicated via network entity 405 and UE 115. For example, the control information may be communicated suing MAC-CE transmissions, RRC transmissions, DCI, transmissions, another transmission, or a combination thereof.

UE 115 can include a variety of components (e.g., structural, hardware components) used for carrying out one or more functions described herein. For example, these components can includes processor 402, memory 404, transmitter 410, receiver 412, encoder, 413, decoder 414, precoding updater 415, tracker 416 and antennas 252a-r. Processor 402 may be configured to execute instructions stored at memory 404 to perform the operations described herein. In some implementations, processor 402 includes or corresponds to controller/processor 280, and memory 404 includes or corresponds to memory 282. Memory 404 may also be configured to store PMI data 406, mobility information data 408, delta precoding data 442, delta power loading data 444, or a combination thereof, as further described herein.

The PMI data 406 includes or corresponds to data associated with or corresponding to a precoding matrix and an indicator/identifier for a precoding matrix (PMI). For example, the PMI data 406 may include a determined or estimated precoding matrix and an identifier (PMI) therefore. The mobility information data 408 includes or corresponds to data indicating device mobility. For example, the mobility information data 408 may include inertial data indicating the devices movement and captured by sensors of the device and/or estimated movement data generated based on one or more pilot signals, a previously determined precoding matrix, or a combination thereof.

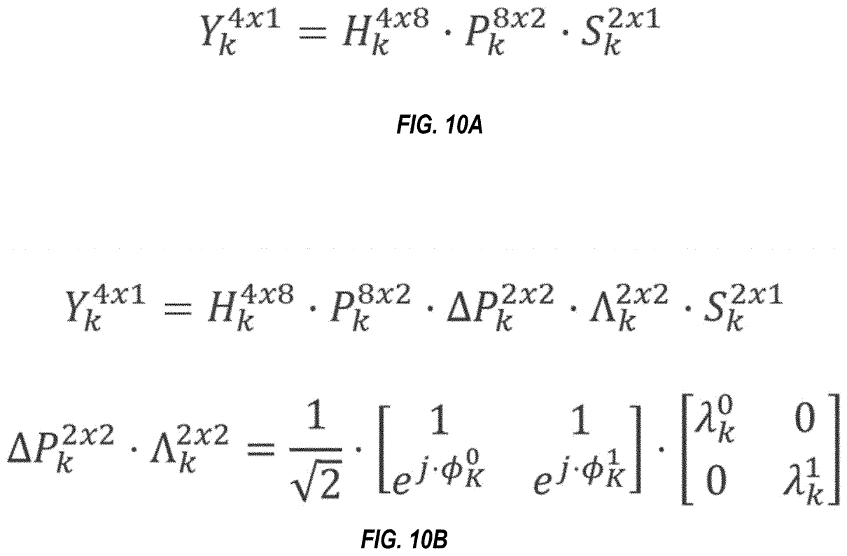

The delta precoding data 442 includes or corresponds to data associated with a change or different in a precoding value or values. The delta precoding data 442 may include a matrix of precoding values in some implementations, as further described with reference to FIGS. 9, 10A, and 10B. The delta power loading data 444 includes or corresponds to data associated with a change or different in a power loading value or values. The delta power loading data 444 may include a matrix of power loading values in some implementations, as further described with reference to FIGS. 9, 10A, and 10B.

Transmitter 410 is configured to transmit data to one or more other devices, and receiver 412 is configured to receive data from one or more other devices. For example, transmitter 410 may transmit data, and receiver 412 may receive data, via a network, such as a wired network, a wireless network, or a combination thereof. For example, UE 115 may be configured to transmit and/or receive data via a direct device-to-device connection, a local area network (LAN), a wide area network (WAN), a modem-to-modem connection, the Internet, intranet, extranet, cable transmission system, cellular communication network, any combination of the above, or any other communications network now known or later developed within which permits two or more electronic devices to communicate. In some implementations, transmitter 410 and receiver 412 may be replaced with a transceiver. Additionally, or alternatively, transmitter 410, receiver, 412, or both may include or correspond to one or more components of UE 115 described with reference to FIG. 2.

Encoder 413 and decoder 414 may be configured to encode and decode data for transmission. Precoding updater 415 may be configured to determine and perform precoding update operations. For example, precoding updater 415 is configured to determine precoding update settings and/or modes and perform precoding update and/or measurement operations. For example, precoding update 415 may cause UE 115 to generate the delta precoding data 442 and the delta power loading data 444. Tracker 416 may be configured to determine and tracking operations. For example, tracker 416 is configured to generate mobility information data 408. For example, tracker 416 is configured receive sensor data from inertial sensors and determine a movement of the UE 115.

Network entity 405 includes processor 430, memory 432, transmitter 434, receiver 436, encoder 437, decoder 438, precoder 439, precoding updater 440, and antennas 234a-t. Processor 430 may be configured to execute instructions stores at memory 432 to perform the operations described herein. In some implementations, processor 430 includes or corresponds to controller/processor 240, and memory 432 includes or corresponds to memory 242. Memory 432 may be configured to store PMI data 406, mobility information data 408, delta precoding data 442, delta power loading data 444, or a combination thereof, similar to the UE 115 and as further described herein.

Transmitter 434 is configured to transmit data to one or more other devices, and receiver 436 is configured to receive data from one or more other devices. For example, transmitter 434 may transmit data, and receiver 436 may receive data, via a network, such as a wired network, a wireless network, or a combination thereof. For example, network entity 405 may be configured to transmit and/or receive data via a direct device-to-device connection, a local area network (LAN), a wide area network (WAN), a modem-to-modem connection, the Internet, intranet, extranet, cable transmission system, cellular communication network, any combination of the above, or any other communications network now known or later developed within which permits two or more electronic devices to communicate. In some implementations, transmitter 434 and receiver 436 may be replaced with a transceiver. Additionally, or alternatively, transmitter 434, receiver, 436, or both may include or correspond to one or more components of network entity 405 described with reference to FIG. 2.

Encoder 437, and decoder 438 may include the same functionality as described with reference to encoder 413 and decoder 414, respectively. Precoding updater 440 may include similar functionality as described with reference to precoding updater 415. For example, precoding updater 440 is configured to receive a precoding update and update a previously sent precoding matrix. To illustrate, the precoding updater 440 may update a CSF indicated precoding matrix or an updated precoding matrix based on delta precoding data 442, delta power loading data 444, or a combination thereof. Precoder 439 is configured to precode (e.g., encode) data based on the precoding matrix, such as the updated precoding matrix.

During operation of wireless communications system 400, network entity 405 may determine that UE 115 has precoding information update capability. For example, UE 115 may transmit a message 448 that includes a precoding information update capability indicator 490. Indicator 490 may indicate precoding information update capability or a particular type or mode of precoding information updating. In some implementations, network entity 405 sends control information to indicate to UE 115 that precoding information updating and/or a particular type of precoding information updating is to be used. For example, in some implementations, message 448 (or another message, such as configuration transmission 450) is transmitted by the network entity 405. The configuration transmission 450 may include or indicate to use precoding information updating or to adjust or implement a setting of a particular type of precoding information updating.

During operation, devices of wireless communications system 400, perform precoding information updating. Precoding information updating may occur after or between CSF operations, as described with reference to FIG. 3. For example, a base station (e.g., 405) may transmit a pilot signal 452 to UE 115. The pilot signal may sent separately or with a data transmission. The pilot signal may be similar to or the same as a pilot signal used to send (e.g., encode) downlink data from the base station to the UE 115. In some implementations, the pilot signal is sent with a data transmission, such as a PDSCH. In some such implementations, the pilot signal corresponds to a DMRS of the PDSCH. In a particular implementation, the pilot signal 452 is a different type of pilot signal from a second type of pilot signal used in channel feedback, such as a CSI-RS type pilot signal used in CSF operations.

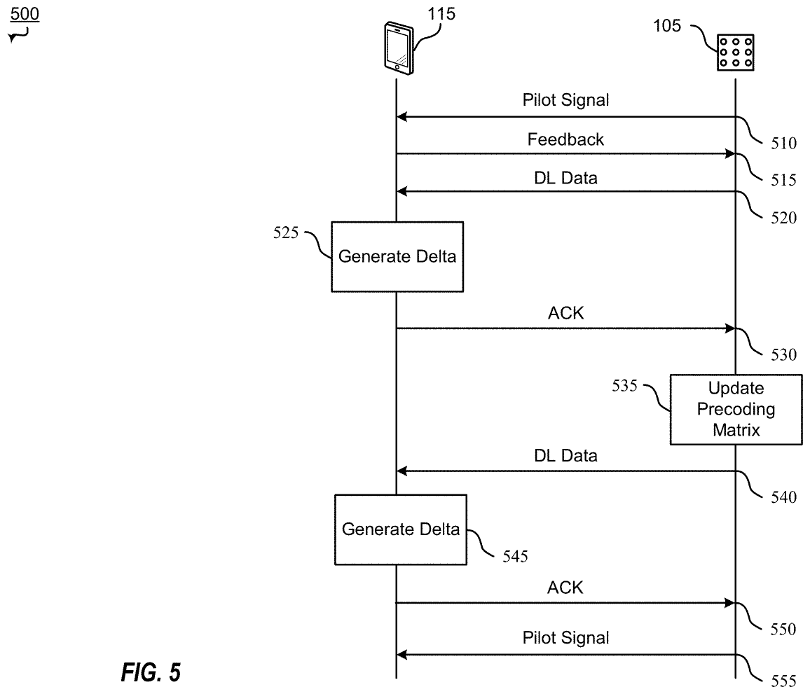

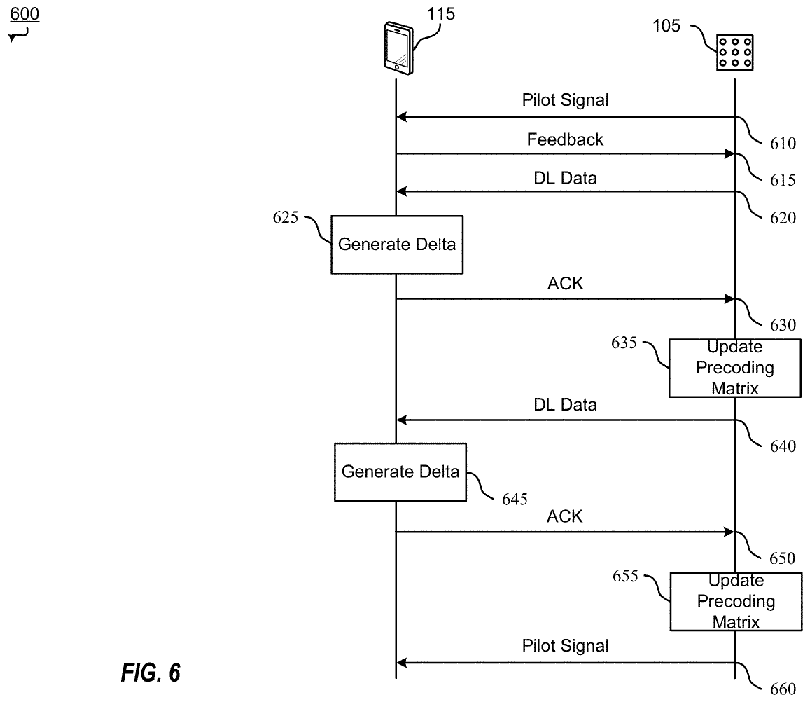

After receiving the pilot signal 452, the UE 115 may generate precoding update information. For example, the UE 115 may generate delta precoding information, delta power loading information, or both. To illustrate, the UE 115 may generate information which indicates an update to a precoding matrix used by the base station 405 which is relative to a previously used or indicated precoding matrix. If multiple delta type updates are generated between conventional precoding updates (e.g., CSF reports), the updates may be serial or cumulative as described further with reference to FIGS. 5 and 6. As another example, the UE 115 may generate an updated PMI and send the updated PMI.

The UE 115 may generate such precoding updates based on the information received from the base station 405, information generated by the UE 115, or both. For example, the UE 115 may estimate channel conditions based on the pilot signal 452, and generate the precoding update information based on the estimated channel conditions. To illustrate, the UE 115 may perform channel estimation based on a DMRS of a control or data transmission to calculate a channel estimation value. Additionally, or alternatively, the UE 115 may track its movement using inertial sensors and generate the precoding update information to account or indicate such movement.

The UE 115 generates a precoding update 454 based on the precoding update information and transmits the precoding update 454 to the base station 405.

After receiving the precoding update 454, the base station 405 may generate an updated precoding matrix. For example, the base station 405 may update the previously used or indicated precoding matrix based on the precoding update 454, such as the precoding update information thereof. To illustrate, the base station 405 may update the previously used or indicated precoding matrix based on the delta precoding information, the delta power loading information, or both. The base station 405 may then send transmissions, such as data, control, and/or sidelink transmissions, to the UE 115 based on the updated precoding matrix.

As illustrated in the example of FIG. 4, the base station 405 generates and transmits one or more data channel transmissions 456 to the UE 115 based on the updated precoding matrix. To illustrate, the base station 405 precodes the one or more data channel transmissions 456 using the updated precoding matrix.

Accordingly, the network entity 405 may be able to transmit information to the UE 115 with a more accurate and updated precoding matrix and channel state information, all without an increase in network overhead (e.g., bandwidth). Thus, network throughput is increased.

Thus, FIG. 4 describes enhanced precoding matrix operations for network operations. Using precoding matrix update operations may enable improvement when networks with mobile devices. Performing precoding matrix update operations enables a network to improve throughput and reliability.

FIGS. 5 and 6 illustrate example ladder diagrams for PMI information updates. Referring to FIG. 5, FIG. 5 is a ladder diagram of an example of serial precoding matrix information updates. Said another way, the update information sent by a device indicates an updated from a most recent or previously used precoding matrix.

At 510, base station 105 generates and transmits a pilot signal. For example, the base station 105 sends a CSI-RS pilot signal to be used for estimating channel conditions and providing channel state feedback. The base station 105 may generate such a CSI-RS periodically, such as every 20 to 80 milliseconds.

At 515, UE 115 generates and transmits a feedback based on the pilot signal. For example, the UE 115 generates a CSF report based on CSF, which is generated based on the pilot signal. To illustrate, the UE 115 generates one or more of the RI, the CQI, or the PMI and includes such in the CSF report.

At 520, the base station 105 generates and transmits first downlink data. For example, the base station 105 transmits a first PDSCH transmission generated based on the CSF report. To illustrate, the base station 105 precodes the transmission based on a precoding matrix indicated by the PMI of the CSF report.

At 525, the UE 115 generates delta precoding information based on the first downlink data. For example, the UE 115 generates a delta precoding value, a delta power loading value, or both. To illustrate, the UE 115 estimates a channel condition based on a DMRS (e.g., first DMRS) of the first PDSCH transmission, and generates precoding information which indicates a change in precoding from the precoding matrix indicated in the CSF report (e.g., the precoding matrix indicated by the PMI of the CSF report). The delta precoding information may be generated further based on device mobility. For example, the UE 115 may track device movement since the feedback was generated or sent and generate the delta precoding information based on the movement, such as to account for the change in device movement.

At 530, the UE 115 transmits the delta precoding information to the base station 105. For example, the UE 115 transmits the delta precoding value, the delta power loading value, or both, in an acknowledgement message, such as an ACK or a NACK, that corresponds to the first PDSCH transmission as shown in the example of FIG. 5.

At 535, the base station 105 updates the precoding matrix based on the delta precoding information. To illustrate, the base station 105 updates the precoding matrix used to send the first PDSCH transmission, which was indicated by the PMI of the feedback from the UE 115, based on the delta precoding value, the delta power loading value, or both.

At 540, the base station 105 generates and transmits second downlink data based on the updated precoding matrix. For example, the base station 105 transmits a second PDSCH transmission generated based on the updated precoding matrix. To illustrate, the base station 105 precodes the second PDSCH transmission based on the updated precoding matrix.

At 545, the UE 115 generates second delta precoding information based on the second downlink data. For example, the UE 115 generates a second delta precoding value, a second delta power loading value, or both. To illustrate, the UE 115 estimates a channel condition based on a DMRS (e.g., second DMRS) of the second PDSCH transmission, and generates second precoding information which indicates a change in precoding from the updated precoding matrix used to send the second PDSCH transmission (e.g., the precoding matrix indicated by the delta precoding information after the CSF report). The second delta precoding information may be generated further based on device mobility. For example, the UE 115 may track device movement since the first delta precoding information was generated or sent and generate the second delta precoding information based on the second movement, such as to account for the change in device movement since the first delta precoding information.

At 550, the UE 115 transmits the second delta precoding information to the base station 105. For example, the UE 115 transmits the second delta precoding value, the second delta power loading value, or both, in a second acknowledgement message, such as an ACK or a NACK, that corresponds to the second PDSCH transmission as shown in the example of FIG. 5.

At 555, the base station 105 generates and transmits a second pilot signal. For example, the base station 105 generates and transmits a second CSI-RS pilot signal to be used for estimating channel conditions and providing channel state feedback. The base station 105 may transmit such a second CSI-RS 20 to 80 milliseconds after the first CSI-RS transmitted at 510.

Thus, in the example in FIG. 5, the UE and base station employ serial precoding matrix information updates. That is, the UE and base station generate and apply updates relative to a most recently signaled or used precoding matrix.

Referring to FIG. 6, FIG. 6 is a ladder diagram of an example of cumulative precoding matrix information updates. Said another way, the update information sent by a device indicates an update from particular previous precoding matrix which may not be the last or most previously used precoding matrix.

At 610, base station 105 generates and transmits a pilot signal. For example, the base station 105 sends a CSI-RS pilot signal to be used for estimating channel conditions and providing channel state feedback. The base station 105 may generate such a CSI-RS periodically, such as every 20 to 80 milliseconds.

At 615, UE 115 generates and transmits a feedback based on the pilot signal. For example, the UE 115 generates a CSF report based on CSF, which is generated based on the pilot signal. To illustrate, the UE 115 generates one or more of the RI, the CQI, or the PMI and includes such in the CSF report.

At 620, the base station 105 generates and transmits first downlink data. For example, the base station 105 transmits a first PDSCH transmission generated based on the CSF report. To illustrate, the base station 105 precodes the transmission based on a precoding matrix indicated by the PMI of the CSF report.

At 625, the UE 115 generates delta precoding information based on the first downlink data. For example, the UE 115 generates a delta precoding value, a delta power loading value, or both. To illustrate, the UE 115 estimates a channel condition based on a DMRS (e.g., first DMRS) of the first PDSCH transmission, and generates precoding information which indicates a change in precoding from the precoding matrix indicated in the CSF report (e.g., the precoding matrix indicated by the PMI of the CSF report). The delta precoding information may be generated further based on device mobility. For example, the UE 115 may track device movement since the CSF was generated or sent and generate the delta precoding information based on the movement, such as to account for the change in device movement.

At 630, the UE 115 transmits the delta precoding information to the base station 105. For example, the UE 115 transmits the delta precoding value, the delta power loading value, or both, in an acknowledgement message, such as an ACK or a NACK, that corresponds to the first PDSCH transmission as shown in the example of FIG. 6.

At 635, the base station 105 updates the precoding matrix based on the delta precoding information. To illustrate, the base station 105 updates the precoding matrix used to send the first PDSCH transmission, which was indicated by the PMI of the feedback from the UE 115, based on the delta precoding value, the delta power loading value, or both.

At 640, the base station 105 generates and transmits second downlink data based on the updated precoding matrix. For example, the base station 105 transmits a second PDSCH transmission generated based on the updated precoding matrix. To illustrate, the base station 105 precodes the second PDSCH transmission based on the updated precoding matrix.

At 645, the UE 115 generates second delta precoding information based on the second downlink data. For example, the UE 115 generates a second delta precoding value, a second delta power loading value, or both. To illustrate, the UE 115 estimates a channel condition based on a DMRS (e.g., second DMRS) of the second PDSCH transmission, and generates second precoding information which indicates a change in precoding from the precoding matrix indicated in the CSF report (e.g., the precoding matrix indicated by the PMI of the CSF report). The second delta precoding information may be generated further based on device mobility. For example, the UE 115 may track device movement since the CSF was generated or sent and generate the second delta precoding information based on the second movement, such as to account for the total change in device movement since the CSF.

At 650, the UE 115 transmits the second delta precoding information to the base station 105. For example, the UE 115 transmits the second delta precoding value, the second delta power loading value, or both, in a second acknowledgement message, such as an ACK or a NACK, that corresponds to the second PDSCH transmission as shown in the example of FIG. 6.

At 655, the base station 105 updates the precoding matrix based on the second delta precoding information. To illustrate, the base station 105 updates the precoding matrix used to send the first PDSCH transmission, which was indicated by the PMI of the feedback from the UE 115, based on the delta precoding value, the delta power loading value, or both. The base station 105 may generate and transmit third downlink data based on the second updated precoding matrix, similar to as described above.

At 660, the base station 105 generates and transmits a second pilot signal. For example, the base station 105 generates and transmits a second CSI-RS pilot signal to be used for estimating channel conditions and providing channel state feedback. The base station 105 may transmit such a second CSI-RS 20 to 80 milliseconds after the first CSI-RS transmitted at 510.

As compared to the example in FIG. 5, which uses serial updates for precoding information updates, the example of FIG. 6 employs cumulative updates for precoding information updates. That is, the UE and base station generate and apply updates relative to a particular precoding matrix which may not be the last used or reported precoding matrix. In a particular implementation the cumulative update is relative to a last reported precoding matrix (e.g., a precoding matrix indicated by a PMI of a CSF report). In other implementations, a UE and/or a base station may be configured to operate in either mode, i.e., use serial or cumulative updates. Particular devices may be set to operate in one mode depending on hardware capabilities or may switch between the modes of FIGS. 3, 5, and/or 6 based on one or more conditions or inputs.

FIGS. 7 and 8 are exemplary diagrams illustrating the effect of device mobility on channel state feedback. Specifically, FIGS. 7 and 8 depicts Jakes Doppler Model Correlation as a function of slots for 5G NR, with FIG. 7 depicting FR1 and FIG. 8 depicting FR2. Both plots look similar due to the selection of a SCS of 30 k for FR1 and a SCS of 120 k for FR2 and due to the selection of a Fc of 6G for FR1 and a Fc of 28G for FR2. While the usage of Jakes Doppler model is not optimal for FR2, it accurate enough to illustrate the issue device mobility has on the accuracy of channel state feedback over time.

As mentioned, the CSI-RS resource and CSF report periodicity in FR2 is approximately 80 msec, (640) slots, while in FR1 the periodicity is approximately 20 msec, (40) slots, meaning that even for channels with small mobility, the CSF feedback doesn't hold, and significant averaging should be applied in UE/gNB in order to define the CQI/RI, mainly since the PMI is not valid.

In practical deployments, in order to deal with mobility, the PMI is often set to be random (per PRG) in case of a higher Rank (e.g., ranks greater than 1), or the Rank is reduced to 1 (and CDD is applied), in order to benefit from frequency diversity. This random PMI approach (and/or Rank reduction), comes with the cost of approximately 30-60% throughput degradation.

In order to deal with mobility the gNB may use an external mechanism (OLLA=Open Loop Link Adaptation) that adapts the CQI based on the ACK/NACK message that is sent by the UE per each transport block. One issue with such operations is that the gNB can only decrease/increase the MCS/RANK, but without knowing by how by how much.

Others have proposed to update the structure of a HARQ message, to also include the “delta spectral efficiency” for the next resource value (RV) to be sent. However, such a proposal may not provide enough information for the base station to fix the drop in efficiency, it only accommodates the lower efficiency by a more precise adjustment of MCS/RANK. Thus, such a proposal prevents overestimating or underestimating the potential throughput, but such a proposal does not increase throughput.

FIG. 9 illustrates representative mathematical equations 902 and 904 for one example precoding update. A conventional precoding equation for channels that apply precoding is Yₖ=Hₖ·Pₖ·Sₖ, where Hₖ is the channel spatial response at a particular subband or subchannel, such as SC k, Pₖ is the spatial precoding at SC k, and Sₖ is transmitted data at SC k. In practice the CSF feedback is per subband (SB), while for this example it is presented as per subchannel (SC).

The spatial precoding, Pₖ, is usually dictated by CSF feedback from UE to gNB and based on CSI-RS. The spatial precoding, Pₖ, is selected based on the channel spatial response, Hₖ, in order to increase (e.g., maximize) SPEF/SNR (spectral efficiency/signal-to-noise ratio).

Equation 902 illustrates one example precoding equation that utilizes precoding updates. Specifically, equation 902 illustrates the conventional precoding equation along with two new terms, a delta precoding term 912 and a delta power loading term 914, which add another layer of precoding and power loading. The delta precoding term 912, the delta power loading term 914, or both, may correspond to a precoding update. The delta precoding term 912 may represent rotation, and the delta power loading term 914 may represent a magnitude and/or sign of the rotation.

Equation 904 illustrates the two new terms (912 and 914) in expanded form. Particularly, equation 904 illustrates representative matrices for the delta precoding term 912 and the delta power loading term 914.

With regards to the delta precoding term 912, the dimension of the delta precoding matrix is L×L, where L is the number of layers (e.g., Rank). The delta precoding matrix consists of a set of steering vectors, where each steering vector represents the “delta” in spatial domain, that is caused by device mobility. As illustrated in Equation 904, the delta precoding matrix is multiplied by a loading matrix which represents the delta power loading term 914.

Each column of the delta precoding matrix (steering vector) gives coefficients of linear combination of precoding vectors (columns) in the precoding, so after applying the delta precoding matrix each layers goes with some new precoding vector as a linear combination of what is used in the delta precoding matrix.

The number of vectors ϕₖ^{L} is dictated by the numbers of layers L, while the numbers of different values of ϕₖ^{L} is dictated by log₂ K bits. In 5G NR FR2 for example, in all practical cases the feedback is not per SB, but per WB, so the load is very small, as NumSb.

In some implementations, predefined combinations of the delta precoding matrix can be stored, at the UE, the gNB, or both. The predefined combinations may also be set by one or more standards. In some such implementations, the predefined combinations may be signaled or indicated by an index. Such storing of precoding matrices may reduce processing overhead, and such signaling of the predefined of precoding matrices may reduce network/bandwidth overhead. As an example, a list of possible angle rotations of the vectors may be stored in a date table or information element and indicated by an index value or angle.

FIGS. 10A and 10B illustrate modified equations for a particular illustrative example. The example case illustrated in FIGS. 10A and 10B is a case that has two (2) allocated layers (i.e., a Rank of 2), eight (8) TX ports, and four (4) RX ports. FIG. 10A illustrates the conventional precoding equation modified for the above parameters. For such an example case, the mathematical expression of FIG. 9 is modified as shown in FIG. 10B to account for such parameters.

A UE may report eight (8) extra bits for the precoding update in such a case. For example, using K=4, log₂ K=2, M=4, log₂ M=2 results in 2+2 bits per layer for the precoding update. The UE may report the values of ΔPₖ (aka ϕₖ⁰ and ϕₖ¹) and Λₖ (aka λₖ⁰ and λₖ¹) in the precoding update. These values are matched, in sense of max SNR/SPEF, using singular value decomposition (SVD) to the Hₖ·Pₖ, which may be estimated based on a pilot signal (e.g., DMRS). To illustrate, the UE may perform channel estimation based on a DMRS of a control or data transmission to calculate a channel estimation value, H_k·P_k.

In order to achieve most of the gains due to power loading, two (2) bits are enough for precoding and two (2) bits are enough for power loading, so adding 2+2 extra bits per layer will bring us very close to the theoretical maximum possible SPEF even in high mobility cases. In other implementations, additional bits or fewer bits may be used for the precoding update.

Additionally or alternatively, other adjustments can be made to reduce or increase bandwidth. In some planned FR2 deployments, only WB precoding is applied, so no significant load in exists for UL in such cases. In FR1, the report (and precoding) is often per SB. For such SB reporting, multiple different bandwidth dependent operations can be used. For example, if the uplink channel can afford extra the extra bits, such as (log₂ K+log₂ M)·L·NumSb≅4·L·NumSb bits, then the devices can operate without comprise and report/apply precoding updates per SB.

If in uplink (UL), the network cannot afford the extra precoding update load and the precoding is reported per SB, the devices can still report/apply the precoding updates per WB, in order to achieve most of the expected benefits (e.g., throughput gains). As such an approach is follows mobility changes, and it doesn't affect the beam characteristics (P_k stay unchanged) and therefore the actual load on uplink is negligible.

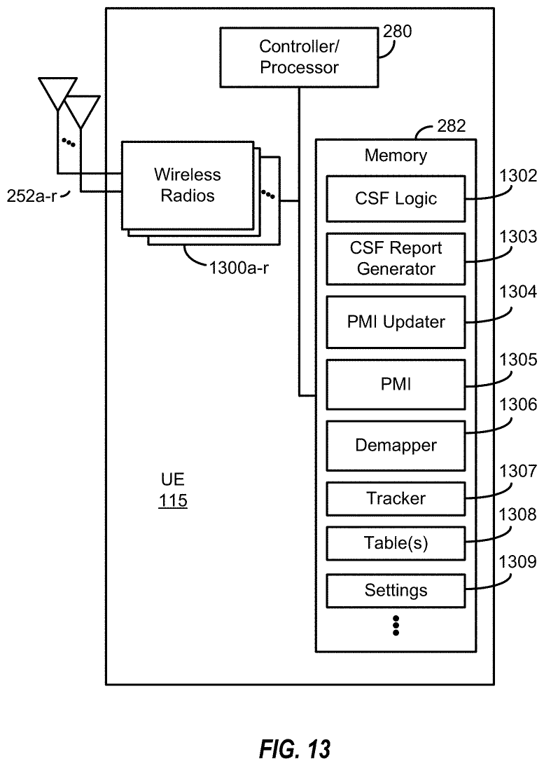

FIG. 11 is a flow diagram illustrating example blocks executed by a UE configured according to an aspect of the present disclosure. The example blocks will also be described with respect to UE 115 as illustrated in FIG. 13. FIG. 13 is a block diagram illustrating UE 115 configured according to one aspect of the present disclosure. UE 115 includes the structure, hardware, and components as illustrated for UE 115 of FIG. 2. For example, UE 115 includes controller/processor 280, which operates to execute logic or computer instructions stored in memory 282, as well as controlling the components of UE 115 that provide the features and functionality of UE 115. UE 115, under control of controller/processor 280, transmits and receives signals via wireless radios 1300a-r and antennas 252a-r. Wireless radios 1300a-r includes various components and hardware, as illustrated in FIG. 2 for UE 115, including modulator/demodulators 254a-r, MIMO detector 256, receive processor 258, transmit processor 264, and TX MIMO processor 266. As illustrated in the example of FIG. 13, memory 282 stores CSF logic 1302, CSF Report Generator 1303, Precoding (e.g., PMI) Updater 1304, PMI data 1305, Demapper 1306, Tracker 1307, table data 1308, and settings data 1309.

At block 1100, a wireless communication device, such as a UE, generates a delta precoding value for a precoding matrix update, the delta precoding value relative to a previous precoding matrix. For example, a UE, such as UE 115, generates a delta precoding value 442 for a precoding matrix update to update a previous precoding matrix indicated in CSF.

At block 1101, the UE 115 generates a delta power loading value for the precoding matrix update, the delta power loading value relative to the previous precoding matrix. For example, the UE 115 generates a delta precoding value 444 for a precoding matrix update, as described with reference to FIGS. 4-6.

At block 1102, the UE 115 transmits a transmission indicating the delta precoding value and the delta power loading value. For example, the UE 115 transmits a precoding matrix (e.g., PMI) update 454 that includes the delta precoding value 442 and the delta precoding value 444, as described with reference to FIGS. 4-6. In some implementations, the update transmission is sent independent of and not in response to CSF operations. In a particular implementation, the update transmission corresponds to an acknowledgment message, such as a HARQ feedback message. The precoding update may be per subband or per wideband (e.g., two or more of subbands).

The UE 115 may execute additional blocks (or the UE 115 may be configured further perform additional operations) in other implementations. For example, the UE 115 may perform one or more operations described above.

In a first aspect, the UE 115 may receive a data transmission precoded based on the delta precoding value, the delta power loading value, or both.

In a second aspect, alone or in combination with the first aspect, the UE 115 may receive, prior to generating the delta precoding value, a data transmission precoded based on the previous precoding matrix, as described in FIGS. 4-6.

In a third aspect, alone or in combination with one or more of the previous aspects, generating the delta precoding value includes estimating the delta precoding value based on a DMRS of the data transmission, and where generating the delta power loading value includes estimating the delta power loading value based on the DMRS of the data transmission.

In a fourth aspect, alone or in combination with one or more of the previous aspects, the UE 115 may track movement by the UE to generate a movement value, and where the delta precoding value, the delta power loading value, or both, are generated further based on the movement value, as described in FIGS. 4-6.

In a fifth aspect, alone or in combination with one or more of the previous aspects, the previous precoding matrix is a precoding matrix used to precode a last downlink data transmission or is a precoding matrix indicated in a latest CSF report, as described in FIGS. 4 and 6.

In a sixth aspect, alone or in combination with one or more of the previous aspects, the transmission comprises an acknowledgment message that corresponds to a data transmission that was precoded based on the previous precoding matrix, and where the acknowledgment message is an ACK or a NACK, as described with reference to FIGS. 4 and 5.

In a seventh aspect, alone or in combination with one or more of the previous aspects, the delta precoding value and the delta power loading value correspond to a particular subband, and further comprising generating a second delta precoding value and a second delta power loading, where the second delta precoding value and the second delta power loading value correspond to a second particular subband different from the particular subband.

In an eighth aspect, alone or in combination with one or more of the previous aspects, the delta precoding value and the delta power loading value correspond to multiple subbands, and further comprising receiving, by the UE, a plurality of transmissions precoded based on the delta precoding value, the delta power loading value, or both, the plurality of transmissions including a first transmission corresponding to a first subband and a second transmission corresponding to a second subband.

In a ninth aspect, alone or in combination with one or more of the previous aspects, the UE 115 may generate a second delta precoding value for a second precoding matrix update, the delta precoding value relative to the updated precoding matrix. The UE 115 may also generate a second delta power loading value for the second precoding matrix update, the delta precoding value relative to the updated precoding matrix. The UE 115 may further transmit a second transmission indicating the second delta precoding value and the second delta power loading value.

In a tenth aspect, alone or in combination with one or more of the previous aspects, the UE 115 may generate a second delta precoding value for a second precoding matrix update, the delta precoding value relative to the previous precoding matrix. The UE 115 may also generate a second delta power loading value for the second precoding matrix update, the delta power loading value relative to the previous precoding matrix. The UE 115 may further transmit a second transmission indicating the second delta precoding value and the second delta power loading value.

In an eleventh aspect, alone or in combination with one or more of the previous aspects, the delta precoding value comprises a matrix of values, and where the matrix has a size of L×L, where L is the number of layers of a link between the UE and a host device.

In a twelfth aspect, alone or in combination with one or more of the previous aspects, the values of the matrix comprises steering vector values from a set of steering vectors, and where each steering vector value represents a relative change in a spatial domain caused by mobility.

In a thirteenth aspect, alone or in combination with one or more of the previous aspects, the delta power loading value comprises a loading matrix.

In a fourteenth aspect, alone or in combination with one or more of the previous aspects, the UE 115 may perform channel estimation based on a DMRS of a data transmission to calculate a channel estimation value), as described with reference to FIG. 4.

In a fifteenth aspect, alone or in combination with one or more of the previous aspects, the UE 115 may perform singular value decomposition (SVD) based on the channel estimation value (H) to determine a unitary matrix (V), and where the delta precoding value, the delta power loading value, or both, are generated further based on the unitary matrix (V), as described with reference to FIGS. 9 and 10.

In a sixteenth aspect, alone or in combination with one or more of the previous aspects, the unitary matrix corresponds to the delta precoding value.

In a seventeenth aspect, alone or in combination with one or more of the previous aspects, generating the delta precoding value includes selecting the delta precoding value from a table (e.g., data table or information element (IE)) stored at the UE based on UE movement, as described with reference to FIGS. 4 and 9. For example, UE rotation can be tracked to generate an angle value (e.g., 5 degrees) and a delta precoding value (e.g., matrix) can be retrieved from the table based on the angle value.

The UE 115 may send or receive one or more precoding update configuration messages, such as a layer precoding configuration message, as described with reference to FIG. 4. For example, in an eighteenth aspect, alone or in combination with one or more of the previous aspects, the UE 115 may, prior to generating the delta precoding value, transmit a capabilities message indicating that the UE is configured for precoding matrix updating. As another example, in a nineteenth aspect, alone or in combination with one or more of the previous aspects, the UE 115 may, prior to generating the delta precoding value, transmit a capabilities message indicating that the UE is precoding matrix update capable UE. As another example, in a twentieth aspect, alone or in combination with one or more of the previous aspects, the UE 115 may, prior to generating the delta precoding value, receive a configuration message from a networking entity indicating a precoding matrix update mode.

In additional aspects the UE 115 may send other types of precoding updates, such as a precoding update including only a delta precoding value or a delta power loading value. For example, in an additional aspect a method of wireless communication includes generating, by a user equipment (UE), a delta precoding value for a precoding matrix, the delta precoding value relative to a previous precoding matrix; and transmitting, by the UE, a transmission indicating the delta precoding value.

As another example in an additional aspect, a method of wireless communication includes generating, by a user equipment (UE), a delta power loading value for a precoding matrix, the delta power loading value relative to a previous precoding matrix; and transmitting, by the UE, a transmission indicating the delta power loading value.

As yet another example in an additional aspect, a method of wireless communication includes generating, by a user equipment (UE), precoding update for a precoding matrix indicated in channel state feedback based on a downlink transmission; and transmitting, by the UE, a transmission indicating the precoding update. For such additional aspects that send other types of precoding updates, one or more of the first through the twentieth aspects may also be performed in conjunction with such additional aspects.

Accordingly, a UE and a base station may perform precoding matrix update (e.g., layer precoding) operations. By performing precoding matrix update (e.g., layer precoding) operations, throughput and reliability may be increased.

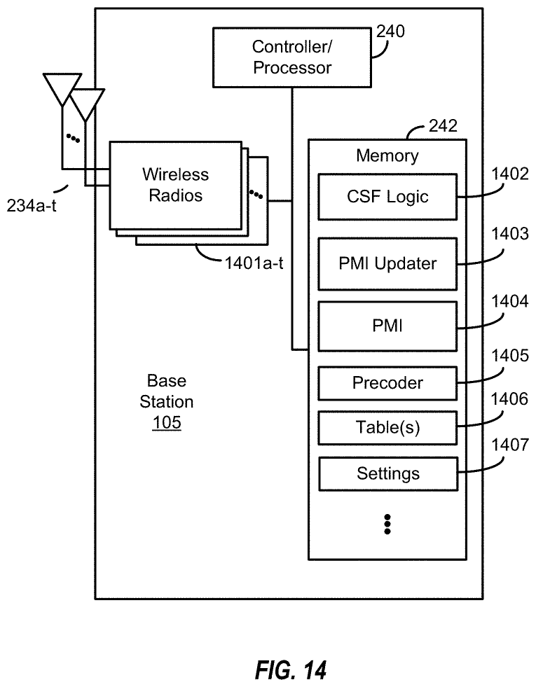

FIG. 12 is a flow diagram illustrating example blocks executed by wireless communication device configured according to another aspect of the present disclosure. The example blocks will also be described with respect to base station 105 (e.g., gNB) as illustrated in FIG. 14. FIG. 14 is a block diagram illustrating base station 105 configured according to one aspect of the present disclosure. Base station 105 includes the structure, hardware, and components as illustrated for base station 105 of FIG. 2. For example, base station 105 includes controller/processor 240, which operates to execute logic or computer instructions stored in memory 242, as well as controlling the components of base station 105 that provide the features and functionality of base station 105. Base station 105, under control of controller/processor 240, transmits and receives signals via wireless radios 1401a-t and antennas 234a-t. Wireless radios 1401a-t includes various components and hardware, as illustrated in FIG. 2 for base station 105, including modulator/demodulators 232a-t, MIMO detector 236, receive processor 238, transmit processor 220, and TX MIMO processor 230. As illustrated in the example of FIG. 14, memory 242 stores CSF Logic 1402, PMI Updater 1403, PMI data 1404, Precoder 1405, table data 1406, and settings data 1407. One of more of 1402-1407 may include or correspond to one of 1302-1309.

At block 1200, a wireless communication device, such as a base station, receives a transmission indicating a delta precoding value and a delta power loading value for a precoding matrix, the delta precoding value and the delta power loading value relative to a previous precoding matrix. For example, base station 105 receives a precoding matrix (e.g., PMI) update 454 that includes the delta precoding value 442 and the delta precoding value 444, as described with reference to FIGS. 4-6. In some implementations, the update transmission is received independent of and not in response to CSF operations. In a particular implementation, the update transmission corresponds to an acknowledgment message, such as a HARQ feedback message.

At block 1201, the base station 105 updates the previous precoding matrix based on the delta precoding value and the delta power loading value to generate an updated precoding matrix. For example, the base station 105 updates or modifies a precoding matrix based on the delta precoding value 442 and the delta precoding value 444, as described with reference to FIGS. 4-6. To illustrate, the base station multiplies the delta precoding value 442 and the delta precoding value 444 by a precoding matrix indicated in a previous CSF report by a PMI or the most recent precoding matrix used to precode downlink data to the UE.

At block 1202, the base station 105 transmits a data transmission based on the updated precoding matrix. For example, the base station 105 precodes data and transmits a data transmission based on the precoded data, as described with reference to FIGS. 4-6.

The base station 105 may execute additional blocks (or the base station 105 may be configured further perform additional operations) in other implementations. For example, the base station 105 may perform one or more operations described above.

In a first aspect, the base station 105 precodes data for the data transmission based on the updated precoding matrix, as described in FIGS. 4-6.

In a second aspect, alone or in combination with the first aspect, the previous precoding matrix is a precoding matrix used to precode a last downlink data transmission or is a precoding matrix indicated in a latest CSF report, as described in FIGS. 4-6.

In a third aspect, alone or in combination with one or more of the previous aspects, the transmission comprises an acknowledgment message that corresponds to a previous data transmission that included the previous precoding matrix, and where the acknowledgment message is an ACK or a NACK, as described in FIGS. 4-6.

In a fourth aspect, alone or in combination with one or more of the previous aspects, the precoding update is per subband or per wideband (e.g., two or more subbands). For example, the delta precoding value and the delta power loading value correspond to a particular subband, and further comprising receiving a second delta precoding value and a second delta power loading, where the second delta precoding value and the second delta power loading value correspond to a second particular subband different from the particular subband.

In a fifth aspect, alone or in combination with one or more of the previous aspects, the delta precoding value and the delta power loading value correspond to a group of subbands or a wideband, and further comprising transmitting, by the network device, a plurality of data transmissions precoded based on the delta precoding value, the delta power loading value, or both, the plurality of data transmissions including the data transmission corresponding to a first subband and a second data transmission corresponding to a second subband.

Accordingly, a UE and a base station may perform precoding matrix update (e.g., layer precoding). By performing precoding matrix update (e.g., layer precoding) operations, throughput and reliability may be increased.

Those of skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

The functional blocks and modules described herein (e.g., the functional blocks and modules in FIG. 2) may comprise processors, electronics devices, hardware devices, electronics components, logical circuits, memories, software codes, firmware codes, etc., or any combination thereof. In addition, features discussed herein relating to precoding updating may be implemented via specialized processor circuitry, via executable instructions, and/or combinations thereof.

Those of skill would further appreciate that the various illustrative logical blocks, modules, circuits, and algorithm steps (e.g., the logical blocks in FIGS. 11 and 12) described in connection with the disclosure herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure. Skilled artisans will also readily recognize that the order or combination of components, methods, or interactions that are described herein are merely examples and that the components, methods, or interactions of the various aspects of the present disclosure may be combined or performed in ways other than those illustrated and described herein.

The various illustrative logical blocks, modules, and circuits described in connection with the disclosure herein may be implemented or performed with a general-purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the disclosure herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor. The processor and the storage medium may reside in an ASIC. The ASIC may reside in a user terminal. In the alternative, the processor and the storage medium may reside as discrete components in a user terminal.

In one or more exemplary designs, the functions described may be implemented in hardware, software, firmware, or any combination thereof. If implemented in software, the functions may be stored on or transmitted over as one or more instructions or code on a computer-readable medium. Computer-readable media includes both computer storage media and communication media including any medium that facilitates transfer of a computer program from one place to another. Computer-readable storage media may be any available media that can be accessed by a general purpose or special purpose computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code means in the form of instructions or data structures and that can be accessed by a general-purpose or special-purpose computer, or a general-purpose or special-purpose processor. Also, a connection may be properly termed a computer-readable medium. For example, if the software is transmitted from a website, server, or other remote source using a coaxial cable, fiber optic cable, twisted pair, or digital subscriber line (DSL), then the coaxial cable, fiber optic cable, twisted pair, or DSL, are included in the definition of medium. Disk and disc, as used herein, includes compact disc (CD), laser disc, optical disc, digital versatile disc (DVD), hard disk, solid state disk, and blu-ray disc where disks usually reproduce data magnetically, while discs reproduce data optically with lasers. Combinations of the above should also be included within the scope of computer-readable media.

As used herein, including in the claims, the term “and/or,” when used in a list of two or more items, means that any one of the listed items can be employed by itself, or any combination of two or more of the listed items can be employed. For example, if a composition is described as containing components A, B, and/or C, the composition can contain A alone; B alone; C alone; A and B in combination; A and C in combination; B and C in combination; or A, B, and C in combination. Also, as used herein, including in the claims, “or” as used in a list of items prefaced by “at least one of” indicates a disjunctive list such that, for example, a list of “at least one of A, B, or C” means A or B or C or AB or AC or BC or ABC (i.e., A and B and C) or any of these in any combination thereof.

The previous description of the disclosure is provided to enable any person skilled in the art to make or use the disclosure. Various modifications to the disclosure will be readily apparent to those skilled in the art, and the generic principles defined herein may be applied to other variations without departing from the spirit or scope of the disclosure. Thus, the disclosure is not intended to be limited to the examples and designs described herein but is to be accorded the widest scope consistent with the principles and novel features disclosed herein.

What is claimed is:

1. A method of wireless communication comprising:
generating, by a user equipment (UE), a delta precoding value for a precoding matrix update, the delta precoding value relative to a previous precoding matrix;
generating, by the UE, a delta power loading value for the precoding matrix update, the delta power loading value relative to the previous precoding matrix; and
transmitting, by the UE, a transmission indicating the delta precoding value and the delta power loading value.

2. The method of claim 1, further comprising receiving, by the UE, a data transmission precoded based on the delta precoding value, the delta power loading value, or both.

3. The method of claim 1, further comprising, receiving, by the UE prior to generating the delta precoding value, a data transmission precoded based on the previous precoding matrix.

4. The method of claim 3, wherein generating the delta precoding value includes estimating the delta precoding value based on a demodulation reference signal (DMRS) of the data transmission, and wherein generating the delta power loading value includes estimating the delta power loading value based on the DMRS of the data transmission.

5. The method of claim 4, further comprising, tracking, by the UE, movement by the UE to generate a movement value, and wherein the delta precoding value, the delta power loading value, or both, are generated further based on the movement value.

6. The method of claim 1, wherein the previous precoding matrix is a precoding matrix used to precode a last downlink data transmission or is a precoding matrix indicated in a latest channel state feedback (CSF) report.

7. The method of claim 1, wherein the transmission comprises an acknowledgment message that corresponds to a data transmission that was precoded based on the previous precoding matrix, and wherein the acknowledgment message is an ACK or a NACK.

8. The method of claim 1, wherein the delta precoding value and the delta power loading value correspond to a particular subband, and further comprising generating a second delta precoding value and a second delta power loading, wherein the second delta precoding value and the second delta power loading value correspond to a second particular subband different from the particular subband.

9. The method of claim 1, wherein the delta precoding value and the delta power loading value correspond to group of subbands or a wideband, and further comprising receiving, by the UE, a plurality of transmissions precoded based on the delta precoding value, the delta power loading value, or both, the plurality of transmissions including a first transmission corresponding to a first subband and a second transmission corresponding to a second subband of the group of the subbands or the wideband.

10. The method of claim 1, further comprising:
generating, by the UE, a second delta precoding value for a second precoding matrix update, the delta precoding value relative to the updated precoding matrix;
generating, by the UE, a second delta power loading value for the second precoding matrix update, the delta precoding value relative to the updated precoding matrix; and
transmitting, by the UE, a second transmission indicating the second delta precoding value and the second delta power loading value.

11. The method of claim 1, further comprising:
generating, by the UE, a second delta precoding value for a second precoding matrix update, the delta precoding value relative to the previous precoding matrix;
generating, by the UE, a second delta power loading value for the second precoding matrix update, the delta power loading value relative to the previous precoding matrix; and
transmitting, by the UE, a second transmission indicating the second delta precoding value and the second delta power loading value.

12. The method of claim 1, wherein the delta precoding value comprises a matrix of values, and wherein the matrix has a size of L×L, where L is a number of layers of a link between the UE and a host device.

13. The method of claim 12, wherein the values of the matrix comprises steering vector values from a set of steering vectors, and wherein each steering vector value represents a relative change in a spatial domain caused by mobility.

14. The method of claim 1, wherein the delta power loading value comprises a loading matrix.

15. The method of claim 1, further comprising performing channel estimation based on a DMRS of a data transmission to calculate a channel estimation value.

16. The method of claim 15, further comprising performing singular value decomposition (SVD) based on the channel estimation value (H) to determine a unitary matrix (V), and wherein the delta precoding value, the delta power loading value, or both, are generated further based on the unitary matrix (V).

17. The method of claim 16, wherein the unitary matrix corresponds to the delta precoding value.

18. The method of claim 1, wherein generating the delta precoding value includes selecting the delta precoding value from a table stored at the UE based on UE movement.

19. An apparatus configured for wireless communication, the apparatus comprising:
at least one processor; and
a memory coupled to the processor, the processor is configured:
generating, by a user equipment (UE), a delta precoding value for a precoding matrix update, the delta precoding value relative to a previous precoding matrix;
generating, by the UE, a delta power loading value for the precoding matrix update, the delta power loading value relative to the previous precoding matrix; and
transmitting, by the UE, a transmission indicating the delta precoding value and the delta power loading value.

20. The apparatus of claim 19, wherein the delta precoding value comprises a matrix of values, and wherein the matrix has a size of L×L, where L is the number of layers of a link between the UE and a host device, wherein the values of the matrix comprises steering vector values from a set of steering vectors, and wherein each steering vector value represents a relative change in a spatial domain caused by mobility, and wherein the delta power loading value comprises a loading matrix.

21. The apparatus of claim 19, wherein the transmission comprises an acknowledgment message that corresponds to a data transmission that was precoded based on the previous precoding matrix, and wherein the acknowledgment message is an ACK or a NACK.

22. The apparatus of claim 19, further comprising, prior to generating the delta precoding value, transmitting, by the UE, a capabilities message indicating that the UE is configured for precoding matrix updating.

23. The apparatus of claim 19, further comprising, prior to generating the delta precoding value, receiving, by the UE, a configuration message from a networking entity indicating a precoding matrix update mode.

24. A method of wireless communication comprising:
receiving, by a network device, a transmission indicating a delta precoding value and a delta power loading value for a precoding matrix, the delta precoding value and the delta power loading value relative to a previous precoding matrix;
updating, by the network device, the previous precoding matrix based on the delta precoding value and the delta power loading value to generate an updated precoding matrix; and
transmitting, by the network device, a data transmission based on the updated precoding matrix.

25. The method of claim 24, further comprising:
precoding data for the data transmission based on the updated precoding matrix.

26. The method of claim 24, wherein the delta precoding value and the delta power loading value correspond to a particular subband, and further comprising receiving a second delta precoding value and a second delta power loading, wherein the second delta precoding value and the second delta power loading value correspond to a second particular subband different from the particular subband.

27. The method of claim 24, wherein the delta precoding value and the delta power loading value correspond to a group of subbands or a wideband, and further comprising transmitting, by the network device, a plurality of data transmissions precoded based on the delta precoding value, the delta power loading value, or both, the plurality of data transmissions including the data transmission corresponding to a first subband and a second data transmission corresponding to a second subband of the group of the subbands or the wideband.

28. An apparatus configured for wireless communication, the apparatus comprising:
at least one processor; and
a memory coupled to the processor, the processor is configured:
to receive, by a network device, a transmission indicating a delta precoding value and a delta power loading value for a precoding matrix, the delta precoding value and the delta power loading value relative to a previous precoding matrix;
to update, by the network device, the previous precoding matrix based on the delta precoding value and the delta power loading value to generate an updated precoding matrix; and
to transmit, by the network device, a data transmission based on the updated precoding matrix.

29. The apparatus of claim 28, wherein the previous precoding matrix is a precoding matrix used to precode a last downlink data transmission or is a precoding matrix indicated in a latest channel state feedback (CSF) report.

30. The apparatus of claim 28, wherein the transmission comprises an acknowledgment message that corresponds to a previous data transmission that included the previous precoding matrix, and wherein the acknowledgment message is an ACK or a NACK.
